SEQUENCE LISTING (2 sequences)

SEQ ID NO: 1 - RNA, 22 nt, human let-7b miRNA
ugagguaguagguugugugguu

SEQ ID NO: 2 - DNA, 22 bp, artificial
  synthetic DNA complementary to sequence of let-7b miRNA
aaccacacaacctactacctca

(19) United States
(12) Patent Application Publication
(10) Pub. No.: US 2008/0272006 A1
(43) Pub. Date: Nov. 6, 2008

(54) Electrochemical Method of Detecting an Analyte

(76) Inventor: Zhiqiang Gao, Singapore (SG)

Correspondence Address: KLARQUIST SPARKMAN, LLP, 121 SW SALMON STREET, SUITE 1600, PORTLAND, OR, 97204, US

(21) Appl. No.: 12/095,498

(22) PCT Filed: Nov. 28, 2006
(86) PCT No.: PCT/SG2006/000365

§ 371 Date: May 29, 2008

Related U.S. Application Data
(60) Provisional application No. 60/740,675, filed on Nov. 30, 2005.

(51) Int. Cl. G01N 27/26

(52) U.S. Cl. 205/777.5; 205/792

(57) ABSTRACT

There is presently provided an electrochemical method of detecting an analyte in a sample involving use of electroactive compound Ru(PD)₂Cl₂ as a label.

### CROSS-REFERENCE TO RELATED APPLICATION

This application claims benefit and priority from U.S. provisional patent application No. 60/740,675 filed on Nov. 30, 2005, the contents of which are incorporated herein by reference.

### FIELD OF THE INVENTION

The present invention relates generally to methods for detecting and quantifying an analyte molecule in a sample, for example a peptide, a protein or a nucleic acid, and particularly to electrochemical methods therefor.

### BACKGROUND OF THE INVENTION

Detection of various types of analyte molecules in a sample is commonly used in a wide range of fields, including clinical, environmental, agricultural and biochemical fields. Currently, various techniques are available for the detection and quantification of analyte molecules in a sample, including immunoassays for the detection of proteins, PCR methods for the detection of nucleic acid molecules and blotting techniques for the detection of smaller oligonucleotides.

There exists a need for a method for detecting analyte molecules in a sample, which method is sensitive and simple to use. There is a particular need for such a method that is capable of easily and efficiently detecting and/or quantifying short nucleic acid molecules.

### SUMMARY OF THE INVENTION

In one aspect, there is provided a method of detecting an analyte molecule in a sample, the method comprising: labelling the analyte molecule in the sample with Ru(PD)₂Cl₂ to form an Ru(PD)₂Cl-analyte molecule complex; contacting the sample with a working electrode, the working electrode having a surface with a capture molecule disposed thereon, to capture the Ru(PD)₂Cl-analyte molecule complex from the sample; contacting a redox substrate with the captured Ru(PD)₂Cl-analyte molecule complex under conditions that allow for oxidation or reduction of the redox substrate; and detecting current flow at the working electrode.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a mass spectrum of Ru(PD)₂Cl₂ treated nucleotides (solid lines) and calculated isotopic distribution patterns (dotted lines);

FIG. 2 depicts a photograph of an electrophoresis gel of oligonucleotides: untreated poly(A)₃₀ and poly(U)₃₀ (lane 1); untreated poly(G)₃₀ and poly(C)₃₀ (lane 2); poly(A)₃₀ and poly(U)₃₀ incubated with Ru(PD)₂Cl₂ at room temperature for 30 min (lane 3) and poly(G)₃₀ and poly(C)₃₀ incubated with Ru(PD)₂Cl₂ at room temperature for 30 min (lane 4); poly(A)₃₀, poly(U)₃₀, poly(G)₃₀ and poly(C)₃₀ incubated with Ru(PD)₂Cl₂ at 80° C. for 30 min and hybridized with their untreated complementary oligonucleotides, (lanes 5-8 respectively);

FIG. 3 is a UV-Vis spectrum of 3.3 μM poly(A)₃₀ (trace 1), 100 μM Ru(PD)₂Cl₂ (trace 2) and 3.3 μM Poly(A)₃₀ treated with 100 μM Ru(PD)₂Cl₂ (trace 3);

FIG. 4 depicts voltammograms of 50 nM let-7b (trace 1), 10 nM let-7b (trace 2) and 50 nM mir-92 (trace 3), all treated with Ru(PD)₂Cl₂, detected on electrodes coated with a capture probe complementary to the let-7b sequence (supporting electrolyte was PBS buffer, potential scan rate 100 mV/s);

FIG. 5 (A) depicts cyclic voltammograms of oxidation of 0.10 mM hydrazine solution on an electrode coated with capture probe complementary to let-7b before (trace 1) and after (trace 3) hybridization of 50 nM let-7b, and the hybridized electrode in blank PBS (trace 2); (B) depicts cyclic voltammograms of 1.0 mM hydrazine solution on a blank ITO electrode (trace 1) or in the presence of 0.10 mM Ru(PD)₂Cl₂ (trace 2), or Ru(PD)₂Cl₂ alone (trace 3) on a blank ITO electrode (supporting electrolyte PBS, potential scan rate 100 mV/s); and

FIG. 6 (A) depicts amperometric curves of 25 pM let-7b (trace 1), 25 pM let-7c (trace 2), and 25 pM mir-92 (trace 3) hybridized to capture probe coated electrodes complementary to let-7b; (B) depicts calibration curves for mir-92 (trace 1), let-7b (trace 2) and mir-320 (trace 3).

### DETAILED DESCRIPTION

The present invention relates to an electrochemical assay method for the detection of biological analyte molecules in a sample. The method utilizes the redox active electrocatalytic moiety Ru(PD)₂Cl₂, in which PD refers to 1,10-phenanthroline-5,6-dione. Many ruthenium complexes are able to selectively bind to imine functional groups, which occur in histidine moieties in proteins and peptides and in purine moieties in nucleic acid molecules. Thus, the present invention relates to the use of Ru(PD)₂Cl₂ to bind to imine functional groups and to function as a redox mediator to allow for detection of analyte molecules.

The present invention takes advantage of the fact that the Ru(PD)₂Cl₂ complex is stable under ambient conditions, but undergoes ligand exchange at elevated temperatures, allowing for the coordination of the ruthenium centre with a peptide, protein, nucleic acid molecule or small molecule, provided that such a molecule contains an imine functional group, for example a histidine residue or an adenine or guanine base, or can be detected or recognized using a molecule that includes an imine functional group. Since complexation of the Ru(PD)₂Cl₂ complex with the imine functional group requires heat, it will be understood that the molecule that contains the imine group should be able to withstand heating to the necessary temperature. For example, if the Ru(PD)₂Cl₂ complex is to be complexed directly with a protein, the protein should not be so heat sensitive that it will denature and non-specifically adhere to surfaces when treated to complex with the Ru(PD)₂Cl₂.

The method is based on the association of the Ru(PD)₂Cl₂ complex with the analyte molecule, which allows for detection of the analyte molecule by detecting current generated by a redox reaction catalyzed by the ruthenium centre. The ruthenium centre catalyzes oxidation or reduction of a redox substrate; electrons are then transferred between the ruthenium centre and a working electrode, which is connected through a circuit to a detector that is able to measure current flow. Since the concentration of Ru(PD)₂Cl₂ complex is directly proportional to the concentration of the analyte molecule, the present method can be standardized to allow for quantification of the analyte molecule concentration in solution.

The electron exchange between the Ru centre and the working electrode resets the oxidation state of the Ru centre, making it available to participate in multiple rounds of the redox reaction and electron transfer, which results in amplification of the signal associated with detection of the analyte molecule. Such a feature of the method enables detection of very small quantities of analyte molecule in a sample.

The amplification feature of the method also makes the method particularly useful for the detection of small oligonucleotides in a sample. Current amplification detection methods such as PCR are not suitable for a short oligonucleotide, since if an oligonucleotide is too short, it cannot act as template for the annealing of primers. The present method allows for detection of short oligonucleotides by capture from a sample and combines amplification of the detection signal so as to allow for detection of very small concentrations of the oligonucleotides. For example, oligonucleotides as short as five nucleotides in length can be detected using the present method, although it will be appreciated that the longer the oligonucleotide, the greater specificity of the method, since there is greater risk of cross-reactivity when identification is based on a short nucleotide sequence.

The present method is particularly suited for the detection or quantification of microRNA molecules. MicroRNAs (“miRNAs”) comprise a family of noncoding 18-25 nucleotide RNAs.⁸ Recent progress in miRNA research has shown that miRNAs regulate a wide range of biological functions from cell proliferation to cancer progression.^{8,9} It is widely believed that miRNA expression analysis may provide the key to its physiological functions. Therefore, there is an urgent need for a reliable and ultrasensitive method for miRNA expression analysis.

Northern blot is currently the most commonly used method in expression analysis of both mature and precursor miRNAs, since it allows gene expression quantification and miRNA size determination.^{10,11,12,13} However, northern blot suffers from limited sensitivity and entails laborious procedures, making it a cumbersome method for routine nucleic acid quantification.

RT-PCR can theoretically amplify a single nucleic acid molecule millions of times and thus is very useful for very small sample size and low abundance genes. Unfortunately, the short length and uniqueness of miRNAs render PCR-based tools ineffective because of the inability of primers to bind such short miRNA templates.^{14,15} RT-PCR is restricted to the detection of miRNA precursors.¹⁶ Although miRNA precursors offer some benefits to the study of miRNA transcript regulation, they may not reflect the exact expression profile of active mature miRNAs. MicroRNA precursors have to undergo several processes before they are in biologically active forms, and equating miRNA precursor levels with the mature miRNAs could be misleading. Therefore, direct quantification of the mature miRNAs is more desirable and reliable.

In view of the extremely small size of miRNAs, a method that employs directly labeling miRNAs themselves may be more advantageous. Recently, Babak and co-workers proposed a cisplatin-based chemical labeling procedure for miRNAs.¹⁷ The miRNA was directly labeled with a cisplatin-fluorophore conjugate through a coordinative bond with G base in miRNA. Another direct labeling procedure at the 3′ end was recently developed by Liang et al.¹⁸ in which miRNAs were first tagged with biotin. After the introduction of quantum dots to the hybridized miRNAs through reacting with quantum dots-avidin conjugates, the miRNAs were detected fluorescently with a dynamic range from 156 pM to 20 nM. Thomson et al. used T4 RNA ligase to couple the 3′ end of miRNA to a fluorophore-tagged ribodinucleotide.¹⁹ The poor reliability and differential ligation efficiency of RNA ligase may compromise the quality of the data. Nonetheless, most of the direct ligation procedures do not offer sufficient sensitivity for miRNA expression analysis.

To further enhance the sensitivity and lower the detection limit, a chemical amplification scheme is employed in the present method. It has been shown that the sensitivity of amplified electrochemical detection of nucleic acids is comparable to that of PCR-based fluorescent assays.^{20,21} However, of the many proposed amplified electrochemical schemes, only a few reports dealt with the detection of RNA, and mRNA in particular.^{22,23} To date, no attempts have been made in electrochemical miRNA assays. The present method involves a labeling procedure that utilizes chemical ligation to directly label miRNA with the redox active and catalytic Ru(PD)₂Cl₂ moiety. The miRNA is labeled in a total RNA mixture in a one-step non-enzymatic reaction under mild conditions. The resulting labeled miRNA allows ultrasensitive detection after hybridization. The chemical amplification mechanism greatly enhances the sensitivity of the assay, lowering thereby the detection limit for miRNA to about 0.50 pM.

The present method is rapid, ultrasensitive, non-radioactive, and is able to directly detect an analyte molecule without requiring biological ligation. By employing Ru(PD)₂Cl₂, an analyte molecule can be directly labeled with redox and electrocatalytic moieties under relatively mild conditions. When applied to detection of specific miRNA, these molecules may be detected amperometrically at subpicomolar levels with high specificity.

Thus, there is presently provided a method for detecting an analyte molecule in a sample. The method comprises labelling the sample with an Ru(PD)₂Cl₂ complex to form an Ru(PD)₂Cl-analyte molecule complex. The Ru(PD)₂Cl-analyte molecule complex is contacted with a working electrode that has a capture molecule disposed on a surface of the working electrode, thus allowing for capture of the Ru(PD)₂Cl-analyte molecule complex. A redox substrate is contacted with the captured Ru(PD)₂Cl-analyte molecule complex under conditions that allow for oxidation or reduction of the redox substrate. Current flow is then detected at the working electrode, which is in circuit with a counter electrode, a biasing source and a device for measuring current flow.

The sample is any sample in which an analyte molecule is desired to be detected, and may comprise a biological sample including a biological fluid, a tissue culture or tissue culture supernatant, a prepared biochemical sample including a prepped nucleic acid sample such as a prepped RNA sample or including a prepped protein sample, a field sample, a cell lysate or a fraction of a cell lysate.

“Ruthenium centre” or “Ru centre” as used herein refers to the R³⁺ ion that forms the metal coordination centre for the Ru(PD)₂Cl₂ complex, including when reduced in a redox reaction to the R²⁺ ion.

The analyte molecule may be any analyte molecule that is desired to be detected in a sample and which is capable of labelling, either directly or indirectly, with an Ru(PD)₂Cl₂ complex. If the analyte molecule is to be labelled directly, it will contain an imine functional group that is accessible for coordination by the ruthenium centre, such that coordination with the ruthenium centre does not interfere with subsequent capture of the analyte molecule by the capture molecule.

A “functional group” is used herein in its ordinary meaning to refer to an atom or group of atoms within a molecule that impart certain chemical or reactive characteristics to the molecule. The term “imine” or “imine functional group” is used herein in its ordinary meaning, to refer to a chemical group within a molecule defined by a bivalent NH group combined with a bivalent nonacid group, for example a carbon-nitrogen double bond.

In various embodiments, the analyte molecule comprises a protein, a peptide, DNA, RNA including mRNA and microRNA, or a small molecule. As stated above, the analyte molecule should be stable enough under the labelling conditions so as to allow for detection once complexed with the Ru(PD)₂Cl₂ complex. Thus, the present method may not be suitable for molecules that may be heat sensitive, for example certain proteins that may denature upon heating to the temperature required to complex with Ru(PD)₂Cl₂ complex, so as not to be recognized by the capture molecule and/or to non-specifically adhere to surfaces. In certain embodiments, the analyte molecule is the let-7b microRNA.

In one embodiment, the analyte molecule is an RNA molecule comprising the sequence UGAGGUAGUAGGUUGUGUGGUU [SEQ ID NO: 1]. In another embodiment, the analyte molecule is an RNA molecule consisting essentially of the sequence of SEQ ID NO: 1. In another embodiment, the analyte molecule is an RNA molecule consisting of the sequence of SEQ ID NO: 1.

“Consisting essentially of” or “consists essentially of” as used herein means that a molecule may have additional features or elements beyond those described provided that such additional features or elements do not materially affect the ability of the molecule to function as an analyte molecule or a capture molecule, as the case may be. That is, the molecule may have additional features or elements that do not interfere with the binding interaction between analyte and capture molecule. For example, a peptide or protein consisting essentially of a specified sequence may contain one, two, three, four, five or more additional amino acids, at one or both ends of the sequence provided that the additional amino acids do not inhibit, block, interrupt or interfere with the binding between the peptide or protein and its target molecule, either analyte or capture molecule. In a further example, a nucleic acid molecule consisting essentially of a specified nucleotide sequence may contain one, two, three, four, five or more nucleotides at one or both ends of the specified sequence provided the nucleic acid molecule can still recognize and bind to its target analyte or capture molecule. Similarly, a peptide, protein or nucleic acid molecule may be chemically modified with one or more functional groups provided that such chemical groups.

It will be appreciated that the analyte molecule should be stable enough under conditions for labelling to allow for subsequent recognition and capture by the capture molecule. For example, if the analyte molecule comprises a protein that is to be labelled directly, it should be stable enough under labelling conditions to maintain any structural features that may be required for capture of the analyte molecule by the capture molecule.

As well, it will be appreciated that where the analyte molecule comprises a double stranded nucleic acid, the sample should be heated to a sufficient temperature to melt the double stranded nucleic acid prior to labelling, if subsequent capture by a capture molecule involves capture by a sequence that is complementary to at least a portion of one strand of the double stranded nucleic acid.

The analyte molecule may be labelled directly with the Ru(PD)₂Cl₂ complex, without need for isolation of the analyte molecule from the sample. The Ru(PD)₂Cl₂ complex is stable under ambient conditions, but undergoes ligand exchange with other ligands at elevated temperatures, as with many other similar ruthenium complexes. It is known that many ruthenium complexes tend to selectively bind to imine sites in biomolecules.²⁷ For example, ruthenium complexes can selectively form coordinative bonds with histidyl imidazole nitrogens on proteins and the N₇ site on the imidazole ring of purine nucleotides.²⁸ The substitution of chloride by nucleic acids is believed to be similar to that of cisplatin.²²

Thus, when being labelled directly, the sample containing the analyte molecule, which possesses one or more imine functional groups, is contacted with the Ru(PD)₂Cl₂ complex and heated for sufficient time to promote ligand exchange of a Cl⁻ ion from the Ru(PD)₂Cl₂ complex for the imine functional group in the analyte molecule, resulting in formation of a Ru(PD)₂Cl/analyte molecule complex. For example, the sample may be heated to a temperature from about 70° C. to about 90° C., for about 30 to about 90 minutes.

Alternatively, if the analyte molecule does not contain an imine functional group, the analyte molecule may be labelled indirectly by use of a labelling molecule. The labelling molecule will contain one or more imine functional groups so that it can form a coordination bond with the ruthenium centre in the same manner as described above for an analyte molecule that contains an imine functional group. As well, the labelling molecule will recognize and bind the analyte molecule within the sample, having greater affinity for the analyte molecule than for other molecules that may be present in the sample. It will be appreciated that the labelling molecule should bind to the analyte molecule in such a way so as not to interfere with capture of the analyte molecule by the capture molecule disposed on the working electrode.

The labelling molecule may comprise a protein, a peptide, a ligand, an antibody, a nucleic acid binding protein or protein domain, or an oligonucleotide, or a small molecule containing an imine functional group.

If the sample volume is large enough, the Ru(PD)₂Cl₂ complex may be added directly to the sample. Alternatively, the labelling may be done in a suitable buffer in which both the Ru(PD)₂Cl₂ complex and the analyte molecule are stable, by mixing of the Ru(PD)₂Cl₂ complex and the sample in the buffer. In exemplary embodiments, the buffer may contain a salt at a concentration from about 1 mM to about 2 M and may have a pH from about 4 to about 11. The precise buffer chosen will depend in part on the nature of the sample and the nature of the analyte and/or capture molecule.

If the analyte molecule or labelling molecule contains more than one imine functional group, for example a nucleic acid molecule that includes multiple purine bases, not every imine functional group will necessarily be labelled with the Ru(PD)₂Cl₂ complex. The density of labelling which results will depend in part on the distribution and arrangement of the imine functional groups in the molecule to be labelled. For example, microRNAs may be labelled with an efficiency of about 30% of imine groups being labelled, possibly due to steric hindrance preventing a higher density of labelling from occurring. However, it has been found that a given molecule will tend to be labelled with a consistent density of the Ru(PD)₂Cl₂ complex, allowing for standardization and quantification using the present method.

As well, the Ru(PD)₂Cl₂ complex does not appear to undergo ligand exchange with both Ru—Cl coordination bonds, meaning that cross-linking between two analyte or labelling molecules or within the same analyte or labelling molecule does not tend to be observed. Again, this is possibly due to steric constraints preventing coordination of two imine functional groups by the same Ru centre.

Once the analyte molecule in the sample is labelled, the sample is contacted with a working electrode on which a capture molecule is disposed. The capture molecule is a molecule that recognizes and specifically binds to the analyte molecule. “Specifically binds” or “specific binding” means that the capture molecule binds in a reversible and measurable fashion to the analyte molecule and has a higher affinity for the analyte molecule than for other molecules in the sample. The capture molecule should recognize and bind to the analyte molecule even when the analyte molecule has been labelled, either directly or indirectly, to form an Ru(PD)₂Cl₂/analyte molecule complex.

The capture molecule may comprise a protein, a peptide, a nucleic acid including DNA, RNA and an oligonucleotide, a ligand, a receptor, an antibody or a small molecule. In one embodiment, the capture molecule is a single stranded oligonucleotide with a complementary sequence to the sequence of a single stranded nucleic acid analyte molecule. In one embodiment, the capture molecule is a single stranded oligonucleotide with a sequence complementary to that of a microRNA that is to be detected in the sample. In a particular embodiment, the capture molecule is a single stranded oligonucleotide comprising a sequence that is complementary to the sequence of the let-7b microRNA. In one embodiment, the capture molecule comprises the sequence AACCACACAACCTACTACCTCA [SEQ ID NO: 2]. In another embodiment, the capture molecule consists essentially of the sequence of SEQ ID NO: 2. In another embodiment, the capture molecule consists of the sequence of SEQ ID NO: 2.

The capture molecule is disposed on a surface of the working electrode, meaning that the capture molecule is coated on, immobilized on, or otherwise applied to the working electrode surface. The disposition may involve an electrostatic, hydrophobic, covalent or other chemical or physical interaction between the capture molecule and the working electrode surface. For example, the capture molecule may be chemically coupled to the electrode. Alternatively, the capture molecule may form a monolayer on the surface of the electrode, for example through self-assembly.

The capture molecule should be disposed on the working electrode surface at a density such that the capture molecule can readily recognize and bind the analyte molecule. For example, if the capture molecule is an oligonucleotide, the capture molecule may be disposed on the working electrode surface at a density of about 6.0×10⁻¹² mol/cm² or greater, of about 8.5×10⁻¹² mol/cm² or less, or from about 6.0×10⁻¹² mol/cm² to about 8.5×10⁻¹² mol/cm².

The term “working electrode” refers to the electrode on which the capture molecule is disposed, and means that this electrode is the electrode involved in electron transfer with the Ru centre during the redox reaction. The working electrode may be composed of any electrically conducting material, including carbon paste, carbon fiber, graphite, glassy carbon, any metal commonly used as an electrode such as gold, silver, copper, platinum or palladium, a metal oxide such as indium tin oxide, or a conductive polymeric material, for example poly(3,4-ethylenedioxythiophene) (PEDOT) or polyaniline.

The sample is contacted with the capture molecule on the surface of the working electrode under conditions and for a time sufficient for the capture molecule to recognize and bind the analyte molecule. For example, if the capture molecule is a single stranded oligonucleotide for capturing a single stranded nucleic acid from solution, the sample is added to the working electrode surface along with a suitable hybridization buffer, and the sample is incubated with the capture molecule for sufficient time under mild to stringent hybridization conditions to allow for recognition and binding of the analyte microRNA molecule by the complementary oligonucleotide capture molecule.

For example, the sample may be incubated with the capture probe at a temperature of about 30° C. for about 60 minutes, in a hybridization buffer containing phosphate buffered-saline (pH 8.0), consisting of 0.15 M NaCl and 20 mM NaCl.

Once the Ru(PD)₂Cl₂/analyte molecule complex has been captured by the capture molecule at the surface of the working electrode, the working electrode may optionally be rinsed to remove excess sample or hybridization buffer, for example, 3 to 5 times with a suitable buffer. The rinsing buffer should be of an appropriate pH and buffer and salt concentration so as not to interfere with or disrupt the interaction between the capture molecule and analyte molecule.

After the Ru(PD)₂Cl₂/analyte molecule complex has been captured by the capture molecule, a redox substrate is added to the working electrode surface in a buffer and under conditions suitable for oxidation or reduction of the redox substrate by the Ru centre. The redox substrate is a molecule that is capable of being oxidized or reduced by the Ru centre. If the redox substrate is to be oxidized by the Ru centre, it will have a redox potential that is less positive than the Ru centre; similarly, when the redox substrate is to be reduced by the Ru centre, it will have a redox potential that is more positive than the Ru centre.

Thus, the redox substrate may be any molecule that can be oxidized or reduced by the Ru centre in a redox reaction. In a particular embodiment, the redox substrate is hydrazine. In another particular embodiment, the redox substrate is ascorbic acid.

As will be appreciated, the working electrode will form part of an electrochemical cell. An electrochemical cell typically includes a working electrode and a counter electrode. In the case of a two-electrode system, the counter electrode functions as a reference electrode. In a three-electrode system the electrochemical cell further comprises a separate reference electrode.

In various embodiments the reference electrode may be a Ag/AgCl electrode, a hydrogen electrode, a calomel electrode, a mercury/mercury oxide electrode or a mercury/mercury sulfate electrode.

The electrodes within the electrochemical cell are connected in a circuit to a biasing source, which provides the potential to the system. As well, a device for measuring current, such as an ammeter, is connected in line. The electrodes are in contact with a solution that contains a supporting electrolyte for neutralization of charge build up in the solution at each of electrodes, as well as the redox substrate that is to be oxidized or reduced. In order to initiate the redox reaction, a potential difference is applied by the biasing source. A current can flow between counter electrode and the working electrode, which is measured relative to the reference electrode.

Typically, the applied potential difference is at least 50 mV more positive than the redox potential of the Ru centre or at least 50 mV more negative than redox potential of the Ru centre, depending on the analyte is being oxidized or reduced.

The current generated as a result of electron transfer catalysed by the Ru centre will be directly proportional to the concentration of the Ru centre, and therefore to the concentration of the captured analyte molecule, allowing for quantification of the concentration of the analyte molecule. The current that flows at the working electrode is derived from Ru centres that are specifically associated with captured analyte molecules. A skilled person will understand how to perform a standard curve with known concentrations of a particular analyte molecule, and as described in the Examples set out herein, so as to correlate the level of detected current with detection of a given concentration of the analyte molecule. In this way, the present method can be used to quantify levels of an analyte molecule in a sample.

Since the redox substrate, for example hydrazine, is in excess in the present method, once a particular Ru centre has been reduced or oxidized through an interaction with a redox substrate molecule, the Ru centre can be oxidized or reduced by electron exchange with the electrode, resetting the Ru centre and making it available for a subsequent round of redox reaction with another redox substrate molecule.

Thus, the present method is sensitive and is able to detect very small quantities of analyte molecule in a sample. For example, for detecting microRNAs in a sample, the present method may have a detection range of about 1.0 to about 300 pM, with a lower detection limit of about 0.5 pM in a 2.5 μl volume. This means that as little as about 1.0 attomole of microRNA may be detected using the present method, and that as little as about 50 ng of total RNA preparation may be required as a sample to detect microRNAs.

For each of the above steps, the appropriate solution may be added to the surface of the working electrode using a liquid cell, which may be a flow cell, as is known in the art, or by pipetting directly onto the surface of the working electrode, either manually or using an automated system. The liquid cell can form either a flow through liquid cell or a stand-still liquid cell.

Due to electrode technology that allows for miniaturization of electrodes, the above method can be designed to be carried out in small volumes, for example, in as little as 1 μl volumes. In combination with the very low detection limit, this makes the present method a highly sensitive method of detecting an analyte molecule in a sample, which is applicable for use in point-of-care and in-field applications, including disease diagnosis and treatment, environmental monitoring, forensic applications and molecular biological research applications.

The present methods are well suited for high throughput processing and easy handling of a large number of samples. This electrochemical miRNA assay is easily extendable to a low-density array format of 50-100 working electrodes. The advantages of low-density electrochemical biosensor arrays include: (i) more cost-effective than optical biosensor arrays; (ii) ultrasensitive when coupled with electrocatalysis; (iii) rapid, direct, while being turbidity- and light absorbing-tolerant and (iv) portable, robust, low-cost, and easy-to-handle electrical components suitable for field tests and homecare use.

Thus, to assist in high volume processing of samples, the working electrode may be used in an array of electrodes. Multiple working electrodes may be formed in an array, for use in high throughput detection methods as described above. Each working electrode in the array may comprise a different capture molecule, for detecting a number of different analyte molecules simultaneously. Alternatively, each working electrode in the array may comprise the same capture molecule, for use in screening a number of different samples for the same analyte molecule.

Each working electrode may be located within a discrete compartment, for ease of applying the same or different sample to each surface of each working electrode. Alternatively, each working electrode can be arrayed so as to contact a single bulk solution. An automated system can be used to apply and remove fluids and sample to each working electrode.

A different capture molecule for detecting a particular analyte molecule within a sample may be disposed on respective working electrodes. Each working electrode may then be contacted with the same sample so as to detect multiple analyte molecules within a single sample at one time.

Alternatively, multiple working electrodes may be arranged in an array such that each individual working electrode has the same capture molecule disposed on its surface. A different sample may then be contacted with each respective working electrode. In this way a large number of samples may be screened for a particular analyte molecule.

### EXAMPLES

Materials: Unless otherwise stated, reagents were obtained from Sigma-Aldrich (St Louis, Mo.) and used without further purification. Ru(PD)₂Cl₂ was synthesized from RuCl₃ according to a literature procedure.²⁴ A phosphate buffered-saline (PBS, pH 8.0), consisting of 0.15 M NaCl and 20 mM phosphate buffer, was used for washing and electrochemical measurements. To minimize the effect of RNases on the stability of miRNAs, all solutions were treated with diethyl pyrocarbonate and surfaces were decontaminated with RNASEZAP™ (Ambion, Tex.). Three human miRNAs, namely let-7b, mir-92 and mir-320²⁵ were selected as our target miRNAs. Aldehyde-modified oligonucleotide capture probes used in this work were custom-made by Invitrogen Corporation (Carlsbad, Calif.) and all other oligonucleotides of PCR purity were custom-made by Proligo (Boulder, Colo.). Indium tin oxide (ITO) coated glass slides were from Delta Technologies Limited (Stillwater, Minn.).

Apparatus: Electrochemical experiments were carried out using a CH Instruments model 660A electrochemical workstation (CH Instruments, Austin, Tex.). A conventional three-electrode system, consisting of an ITO working electrode, a nonleak Ag/AgCl (3.0 M NaCl) reference electrode (Cypress Systems, Lawrence, Kans.), and a platinum wire counter electrode, was used in all electrochemical measurements. All potentials reported in this work were referred to the Ag/AgCl electrode. Electrospray ionization mass spectrometric (ESI-MS) experiments were performed with a Finnigan/MAT LCQ Mass Spectrometer (ThermoFinnigan, San Jose, Calif.). Inductively coupled plasma-mass spectrometry (ICP-MS) was conducted with an Elan DRC II ICP-MS spectrometer (PerkinElmer, Wellesley, Mass.). UV-Vis spectra were recorded on a V-570 UV/VIS/NIR spectrophotometer (JASCO Corp., Japan). All experiments were carried out at room temperature, unless otherwise stated.

Total RNA Extraction and Labeling: Total RNA from human HeLa-60 cells were extracted using TRIzol reagent (Invitrogen, Carlsbad, Calif.) according to the manufacturer's recommended protocol. MicroRNAs in the total RNA were enriched using a Montage spin column YM-50 column (Millipore Corporation). RNA concentration was determined by UV-Vis spectrophotometry. Typically, 1.0 μg of total RNA was used in each of the labeling reactions. 20 μl of 0.25 mM Ru(PD)₂Cl₂ in 0.10 M pH 6.0 acetate buffer was added to 5.0 μl of total RNA solution. The mixture was incubated for 30-40 min in an 80° C. water bath and cooled on ice. The labeled RNA was stored at −20° C. after addition of 5.0 μl of 3.0 M KCl.

Electrode preparation, hybridization and detection: The pretreatment, silanization and oligonucleotide capture probes immobilization of the ITO electrode were as previously described.²⁶ The surface density of immobilized capture probes was 6.0-8.5×10⁻¹² mol/cm². The miRNA assay was carried out as follows: First, the electrode was placed in a moisture saturated environmental chamber maintained at 30° C. A 2.5 μl aliquot of hybridization solution, containing the desired amount of labeled miRNA, was uniformly spread onto the electrode, which was then rinsed thoroughly with a blank hybridization solution at 30° C. after a 60 minute hybridization period. The hydrazine electro-oxidation current was measured amperometrically in vigorously stirred PBS containing 5.0 mM hydrazine. At low miRNA concentrations, smoothing was applied after each amperometric measurement to remove random noise and electromagnetic interference.

### FIGURE CAPTIONS

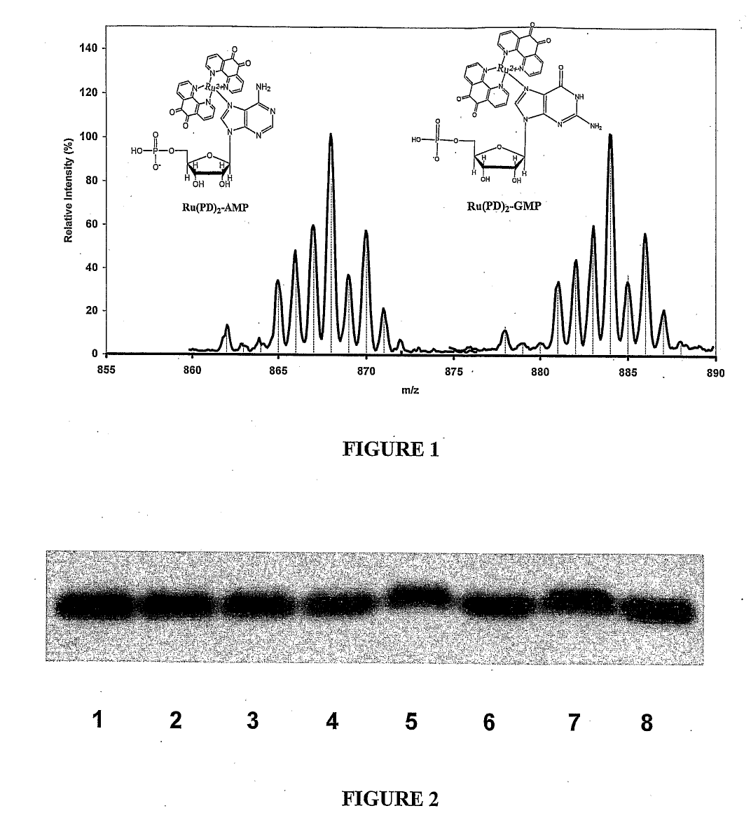

FIG. 1. Mass spectra of Ru(PD)₂Cl₂ treated nucleotides (solid) and calculated isotopic distribution patterns (dotted).

FIG. 2. Gel electrophoresis of oligonucleotides. Untreated (1) poly(A)₃₀ and poly(U)₃₀ and (2) poly(G)₃₀ and poly(C)₃₀; (3) poly(A)₃₀ and poly(U)₃₀ and (4) poly(G)₃₀ and poly(C)₃₀ incubated with Ru(PD)₂Cl₂ at room temperature for 30 min; (5) poly(A)₃₀ (6) poly(U)₃₀, (7) poly(G)₃₀ (8) poly(C)₃₀ incubated with Ru(PD)₂Cl₂ at 80° C. for 30 min and hybridized with their untreated complementary oligonucleotides, respectively.

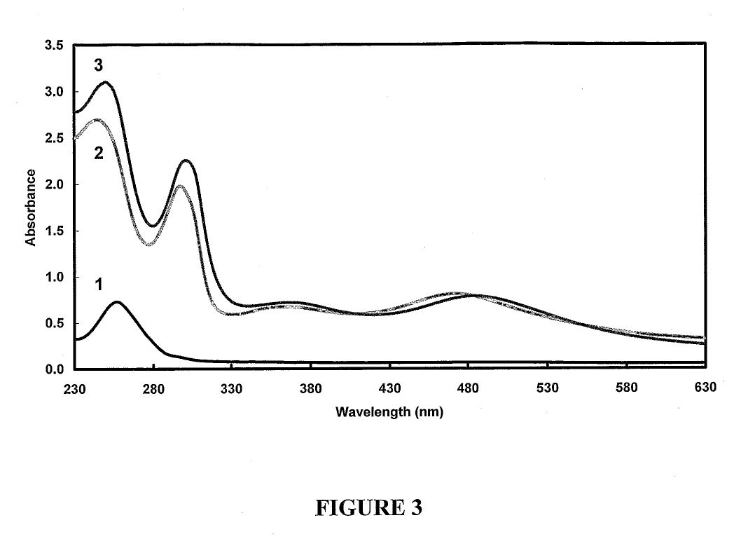

FIG. 3. UV-Vis spectra of (1) 3.3 μM poly(A)₃₀, (2) 100 μM Ru(PD)₂Cl₂ and (3) 100 μM Ru(PD)₂Cl₂ treated 3.3 μM Poly(A)₃₀.

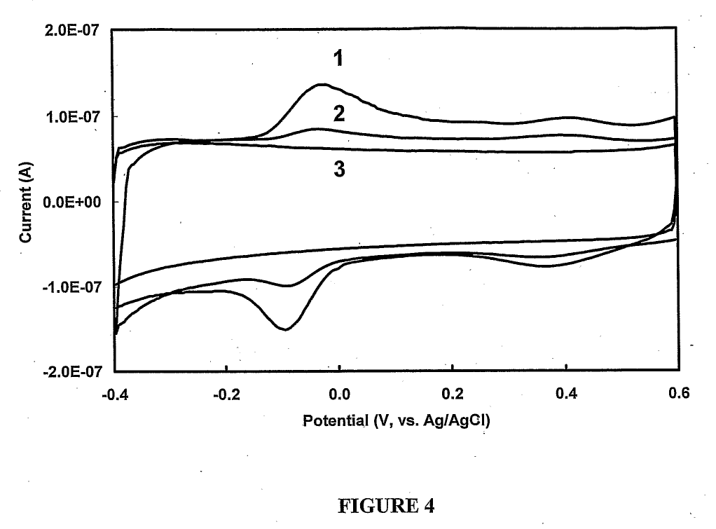

FIG. 4. Voltammograms of Ru(PD)₂Cl₂ treated (1) 50 nM, (2) 10 nM let-7b and (3) 50 nM mir-92 at electrodes complementary to let-7b. Supporting electrolyte PBS buffer, potential scan rate 100 mV/s.

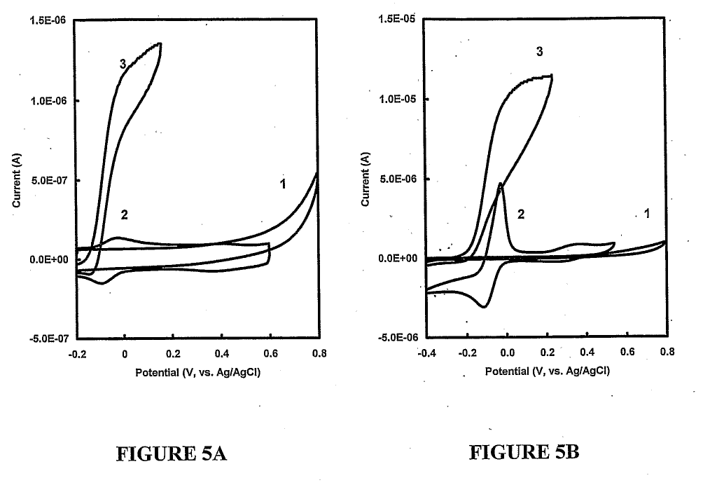

FIG. 5. (A) Cyclic voltammograms of 0.10 mM hydrazine at (1) a capture probe coated electrode before (1) and (3) after hybridization to its complementary 50 nM let-7b, and (2) the hybridized electrode in blank PBS. (B) Cyclic voltammograms of 1.0 mM hydrazine at (1) a blank ITO electrode and (2) in the presence of 0.10 mM Ru(PD)₂Cl₂, and (3) Ru(PD)₂Cl₂ at a blank ITO electrode. Supporting electrolyte PBS, potential scan rate 100 mV/s.

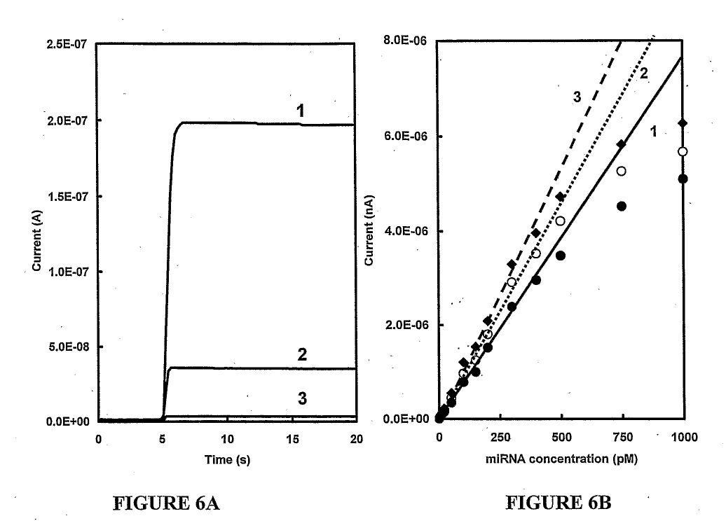

FIG. 6. (A) Amperometric curves of (1) 25 μM let-7b (2) 25 μM let-7c, and (3) 25 μM mir-92 hybridized to capture probe coated electrodes complementary to let-7b. (B) Calibration curves for (1) mir-92, (2) let-7 and (3) mir-320.

### RESULTS

Feasibility of direct labeling miRNA with Ru(PD)₂Cl₂: A direct proof of the formation of nucleotide-Ru(PD)₂Cl₂ adduct would be mass spectrometry. Thus, we first conducted a series of mass spectrometric tests on Ru(PD)₂Cl₂, treated nucleotides, the simplest RNA model compounds. ESI-MS was used to characterize the chemistry between Ru(PD)₂Cl₂ and nucleotides because of the mildness of the ionization process. As depicted in FIG. 1, among the four nucleotides tested only guanosine 5′-monophosphate (GMP) and adenosine 5′-monophosphate (AMP) produced new ion clusters at m/z 868 and 884, which we assigned as [GMP-Ru(PD)₂]⁺ and [AMP-Ru(PD)₂]⁺, respectively, based on excellent matches between the experimental and calculated isotopic distribution patterns and the molecular weights of the adducts (FIG. 1).

ESI-MS tests suggested that only AMP and GMP readily undergo ligand-exchange with chloride in Ru(PD)₂Cl₂. Moreover, the molecular clusters of double-exchanged Ru(PD)₂Cl₂-nucleotide adducts were not observed even after prolonged incubation at 80° C., indicating that Ru(PD)₂Cl₂ undergoes only mono-substitution under the experimental conditions even though it has two cis coordinating labile chloride ligands. The inability of double-ligand exchange is most probably due to steric constraints of Ru(PD)₂Cl⁺ that hinders the binding of more than one purine base, as previously observed in similar ruthenium complexes.²⁹ Double-ligand exchange with the sterically more hindered six-coordinated octahedral ruthenium complexes is evidently much more difficult that it is for square-planar platinum complexes, such as cisplatin.²² However, mono-substitution is a desirable feature in developing chemical ligation procedures for miRNA assays, since it offers an excellent control over the ligation process and prevents from any possible “cross-linking” between miRNA molecules (intermolecular cross-linking) and between purine bases of the same miRNA molecule (intramolecular cross-linking). It is expected that intermolecular cross-linking would affect hybridization efficiency and intramolecular cross-linking would alter the miRNA sequence by generating “loops” in the miRNA strand.

As discussed above, mass spectrometric data clearly indicated that Ru(PD)₂Cl₂ can be grafted onto nucleotides via ligand exchange under mild conditions. However, the introduction of Ru(PD)₂Cl₂ onto oligonucleotides might severely affect hybridization efficiency. To ensure that the labeled oligonucleotides retain their biological integrity, a series of gel electrophoretic tests were performed on oligonucleotides after the Ru(PD)₂Cl₂ treatment. As illustrated in lanes 1 to 4 in FIG. 2, little difference was observed between untreated oligonucleotides and those treated by prolonged incubation with Ru(PD)₂Cl₂ at room temperature, implying that no ligand exchange occurs at room temperature and Ru(PD)₂Cl₂ has little effect on the electrophoretic mobility of the oligonucleotides. On the other hand, distinct changes were obtained among the four oligonucleotides after a 30-min incubation with Ru(PD)₂Cl₂ at 80° C. The electrophoretic mobilities of the treated poly(A)₃₀ and poly(G)₃₀ are slower than poly(U)₃₀ and poly(C)₃₀ (lane 5-8), suggesting that additional mass and/or positive charges are added onto these oligonucleotides; gel electrophoresis confirmed that Ru(PD)₂Cl₂ is successfully grafted onto poly(A)₃₀ and poly(G)₃₀.

More importantly, the presence of Ru(PD)₂Cl⁺ labels on the oligonucleotides poses little hindrance to hybridization efficiency, paving the way for the development of ultrasensitive miRNA assay.

Under identical experimental conditions, little difference was observed between Ru(PD)₂Cl₂ labeled poly(A)₃₀ and poly(G)₃₀, indicating that purine bases in poly(A)₃₀ and poly(G)₃₀ are equally reactive at 80° C. At lower temperatures and/or short reaction times poly(G)₃₀ is slightly more reactive than poly(A)₃₀ reflected by a slightly slower migration. In contrast, the poly(U)₃₀ and poly(C)₃₀ showed little difference from their untreated counterparts (lane 6 & 8), implying that the Ru(PD)₂Cl₂ did not bind to these oligonucleotides.

Quantitative analysis using ICP-MS showed that 28-32% of the G and A bases in the oligonucleotides were successfully labeled. Later experiments showed this labelling efficiency is sufficient for ultrasensitive miRNA assays. From the above data, it is clear that the labeling efficiency is miRNA sequence-dependent since Ru(PD)₂Cl₂ preferentially labels miRNAs with G and A bases in them with an efficiency of 30%.

FIG. 3 illustrates the UV-Vis absorption spectra of the starting materials and the labeled oligonucleotide, using poly(A) as an example. The spectrum of the nucleotide before labeling shows the typical transition of the heterocyclic oligonucleotides around 260 nm (FIG. 3 trace 1). The spectrum of Ru(PD)₂Cl₂ is more or less characteristic of the spectra for Ru—PD complexes.²⁴ It exhibited two intense bands in the UV region due to ligand localized π-π* transitions. The same transitions are found in free PD.²⁴ The two broad bands in the regions 330-400 nm and 430-600 nm are due to spin-allowed Ru(dπ)→PD(π*) metal-to-ligand charge-transfer (MLCT) transitions (FIG. 3, trace 2). The spectrum of the labeled oligonucleotide appeared as a superposition of the nucleotide and Ru(PD)₂Cl₂ with some red shift ˜15 nm in the 430-600 nm region (FIG. 3, trace 3). This is likely a direct consequence of the ligand exchange. The purine group is conjugated, resulting in a lower π* level for this ligand relative to the chloride of the complex, again confirming the formation of the Ru(PD)₂Cl₂-Poly(A) adduct.

Next, thermal melting was conducted between 20° C. and 70° C. to evaluate the stability of the hybridized oligonucleotides. A mixture of the complementary nucleotide strands was first heated to 70° C. and then slowly cooled down to room temperature. It was found that the presence of Ru(PD)₂Cl⁺ in the oligonucleotides slightly destabilizes the duplex when compared to their unlabeled counterparts (ΔTₘ=−1.0° C. for poly(G)₃₀ and −2° C. for poly(A)₃₀). Several factors may possibly contribute to the slightly reduced stability of the labeled oligonucleotides, including electrostatic interaction, steric hindrance and solvation. The introduction of cationic Ru(PD)₂Cl⁺ is expected to stabilize the duplex by reducing net electrostatic repulsion between the two strands; the presence of the bulky label and the aromatic ligands in the major groove may reduce the stability of the duplex by repelling water molecules and bound small cations. From the thermal melting experiments, it is evident that the most of destabilization effect is compensated for by the electrostatic interaction.

Hybridization and Feasibility Study of miRNA Detection: Nucleic acid assays with electrocatalytic labels have previously been reported.^{30,31} The labels give greatly enhanced analytical signals to hybridized electrodes compared to non-hybridized ones. The difference in amperometric currents is used for quantification purpose. In a similar way, Ru(PD)₂Cl⁺ was evaluated as a novel electrocatalytic label for possible applications in ultrasensitive miRNA assay.

In the first hybridization tests, electrodes coated with capture probes complementary to let-7b were used to analyze let-7b and mir-92 (non-complementary, control). Upon hybridization, the complementary let-7b was selectively bound to the capture probes and became fixed on the electrode surface. On the contrary, little if any of the non-complementary mir-92 was captured during hybridization, hence minute voltammetric response of the electrode was expected. It was found that extensive washing with a NaCl-saturated phosphate buffer (pH 6.0) containing 0.10 mM ascorbic acid removed most of the non-miRNA related Ru(PD)₂Cl₂ uptake from the labeling solution since there is little interaction between the neutral Ru(PD)₂Cl₂ and oligonucleotides on the electrode surface. Cyclic voltammograms for the electrodes after hybridization to let-7b and mir-92 are shown in FIG. 4. No obvious voltammetric activities were observed after hybridization to mir-92 (FIG. 5 trace 1), indicating that there is very little non-hybridization-related uptake of mir-92.

As shown in traces 2 and 3 in FIG. 5, after hybridization to different amounts of let-7b miRNA, two pairs of voltammetric peaks were observed and the peak currents are directly proportional to the concentration of let-7b in solution. The current peaks near −0.10 V are due to the redox processes of the coordinated PD ligands and those at 0.40 V to the redox process of the metal center.²⁴ These results clearly demonstrated that the labeled miRNA selectively hybridizes with its complementary capture probe on the electrode surface with very little cross-hybridization.

Consequently, the usage of Ru(PD)₂Cl⁺ as a redox active indicator for direct detection of miRNA was evaluated. A detection limit of 2.0 nM and a dynamic range up to 500 nM were obtained. The hybridization efficiency at the high end of the dynamic range was evaluated electrochemically using the Ru(PD)₂Cl₂ label on the miRNA. The number of Ru(PD)₂Cl⁺ molecules producing the observed current was estimated from the charge under the first oxidation current peak. Since four electrons are transferred per label, the observed current of 0.49 μA after hybridization to 500 nM of the complementary target miRNA, resulted therefore from 1.9 pmol of active and labeled Ru(PD)₂Cl⁺. Assuming a Ru(PD)₂Cl⁺/RNA base pair ratio of ˜1/3, the hybridization efficiency was found to be ˜18%, corresponding to ˜20% of target miRNA in the sample droplet, which is comparable to the values found in the literature.^{21,30,32}

In the second tests, the electrodes before and after hybridization were evaluated volumetrically and amperometrically in PBS containing 0.10 mM hydrazine. FIG. 5A shows cyclic voltammograms of hydrazine at the electrode before (FIG. 5A, trace 1) and after hybridization (FIG. 5A, trace 3). For comparison, a voltammogram of the hybridized electrode in blank PBS is also presented (FIG. 5A trace 2).

Both electrodes showed a totally irreversible oxidation process for hydrazine. Before hybridization the anodic peak potential (E₁) for hydrazine oxidation is beyond 0.80 V, largely due to oxidation overpotential and the presence of MD and anionic oligonucleotide capture probes. Both of them substantially impede electron exchange between the underlying electrode and hydrazine. It can be seen that the presence of Ru(PD)₂Cl greatly reduced the overpotential of hydrazine oxidation, shifting the Eₚ value negatively by as much as 850 mV to −0.050 V.

To ensure that the enhanced current is indeed form the genuine catalytic effect of Ru(PD)₂Cl, voltammetric tests were conducted in homogeneous Ru(PD)₂Cl₂ solution. A cyclic voltammogram recorded with a blank ITO electrode in a 0.10 mM solution of Ru(PD)₂Cl₂ is shown in FIG. 5B. Several aspects of the voltammogram are noteworthy. The first oxidation peak is much higher and sharper than other peaks, mainly due to strong adsorption of Ru(PD)₂Cl₂, a phenomenon previously studied by Anson.³³ The cathodic peak at −0.10 V, produced by the reduction of PD ligands in the complex is much larger than peaks for the Ru(III)/Ru(II) processes ˜0.30 V, because four electrons are involved in the reduction of the two PD ligands coordinated to each ruthenium center. The single cathodic peak, instead of two separated peaks, suggests that the two PD ligands in the complex interact with the metal center approximately equally and they do not interact sufficiently with each other to alter their redox potential substantially, so that the two PD ligands are reduced in a single, four-electron step that consists of two simultaneous two-electron reductions of PD. Theoretically, the cathodic peak current would be expected to be 2^{3/2}×2=5.6 times as large as the peak current for the one-electron oxidation of Ru(II) to Ru(III).³⁴ The actual ratio of the peak current is not far from the theoretical value, but an exact match is not expected because of the complications caused by adsorption/desorption processes.³³

It is well documented that the direct oxidation of hydrazine suffers from very large overpotentials. Reported values for its oxidation potential range form 0.40-1.0 V. In the presence of Ru(PD)₂Cl₂, a voltammogram of hydrazine, shown in trace 3 FIG. 5B, was obtained. It is immediately apparent that there is a very strong catalytic effect by the metal complex since the current at potentials in the vicinity of the PD redox potential increases dramatically, indicating that the complex is being turned over by the oxidation of hydrazine. The increase in peak current and the decrease in the anodic overpotential demonstrated an efficient electrocatalysis of hydrazine. The shift in the overpotential is due to a kinetic effect, hence greatly increases the rate of electron transfer from hydrazine to the electrode, which is attributed to the improvement in the reversibility of the electron transfer processes. The fact that the current increases when increasing hydrazine concentration suggests that the electrocatalytic effect is very efficient the overall process is solely controlled by the diffusion of hydrazine to the electrode surface.

On the basis of the above voltammetric investigations, it seems highly likely that better analytical characteristics can be achieved in amperometry. The feature of the electrocatalysis that appears to be particularly promising is the extremely low potential at which hydrazine oxidation takes place. Amperometric detection at significantly lower operating potentials minimizes potential interferants and reduces the background signal, yielding an improved signal/noise ratio and a lower detection limit. As demonstrated in FIG. 6, upon addition of 5.0 mM hydrazine to PBS, the oxidation current in amperometry increased to 195 nA at 0.10 V at the electrode hybridized to 25 pM of the complementary target miRNA (FIG. 6A trace 1), whereas the electrode hybridized with non-labeled miRNA gave an oxidation current practically indistinguishable from the background noise. Furthermore, in a control experiment in which the non-complementary target miRNA was used, only a 3.2 nA increment in hydrazine oxidation current was observed (FIG. 6A trace 3), largely due to the residual non-hybridization-related uptake of Ru(PD)₂Cl₂.

The specificity of the assay for detection of target miRNA was further evaluated by analyzing let-7b and let-7c with the electrodes coated with capture probes complementary to let-7b. There is only one nucleotide difference (G++A) in 22 nucleotides between let-7b and let-7c. In other words, the capture probe for let-7b is one base-mismatched for let-7c. As shown in trace 2 in FIG. 6A, the current increment dropped by ˜80% to as low as 36 nA when let-7c was tested on the electrode, readily allowing discrimination between the perfectly matched and mismatched miRNAs. The amperometric data agreed well with the voltammetric results obtained earlier and confirmed that the target RNA was successfully detected with high specificity and sensitivity. Therefore, each quantified result represents the specific quantity of a single miRNA member and not the combined quantity of the entire family.

Calibration curves for miRNAs: In this study, the three representative miRNAs with a (G+A) content from 30 to 80%, covering the entire range of (G+A) content of known human miRNAs, were selected. Analyte solutions with different concentrations of Ru(PD)₂Cl₂ labeled miRNAs, ranging from 0.10 to 1000 pM, were tested. For the control experiments, non-complementary capture probes were used in the sensor preparation.

As depicted in FIG. 6B, the dynamic range was 1.0-300 pM, with a detection limit of 0.50 pM (1.0 attomole). Compared to previous chemical ligation-based miRNA assays, the sensitivity of miRNA analysis was greatly improved by adopting the multiple labeling and chemical amplification scheme of the present method. In the earlier reported assays the ratio of label and target miRNA molecule was fixed at 1:1. The amount of capture probes immobilized on the sensor surface and hybridization efficiency determined the amount of target miRNA bound to the surface and thereby the amount of labels.

However, in our method, multiple Ru(PD)₂Cl⁺ labels on a single miRNA strand greatly increased the label loading, accordingly the corresponding response from electrocatalytic oxidation was increased, and hence the sensitivity and detection limit of the miRNA assay were substantially improved. The label:base ratio was estimated to be in the range of 1:3 to 1:4 depending on the sequence of individual miRNA molecule. Theoretically, if this ratio remains unchanged for all miRNAs, the same current sensitivity per base should be obtained for all miRNAs. At the same molar concentration, the sensitivity should be roughly proportional to the number of base in the miRNA, but this trend was not observed in our experiments. It was noteworthy that the sensitivity per base is, however, miRNA sequence and (G+A) content dependent. However, no straightforward relation between (G+A) content and current sensitivity was observed. This is probably due to the fact that G and A are not evenly distributed. Owing to steric hindrance and three-dimensional packing of the miRNA molecules on the sensor surface, it would likely be extremely difficult to label G and A bases when in a cluster, so a less labeling efficiency would be expected. For example, the (G+A) content (78%) in mir-320 is more than doubled as compared to that of mir-92, but the sensitivity for mir-320 was merely 35% higher than that of mir-92.

Analysis of miRNA Extracted from HeLa cells: The assay was applied to the analysis of the three miRNAs in total RNA extracted from HeLa cells to determine the ability in quantifying miRNAs in real world samples. The results were normalized to total RNA, as listed in Table 1. These results are in good agreement with Northern blot analysis on the same sample and consistent with recently published data of miRNA expression profiling.^{35,36,37} The lowest amount of total RNA needed for successful miRNA detections was found to be ˜50 ng, corresponding to ˜1000 HeLa cells. The relative errors associated with miRNA assays on individual miRNAs were generally less than 15% in the concentration range of 2.0 to 300 pM. Therefore, it allows us to identify miRNAs that differ less than 2-fold in expression between two conditions. In many cases the expressions of many of the most interesting miRNAs may only differ a little between different conditions. The proposed procedure allows a greater accuracy in the identification of differentially expressed miRNAs and reduces the need for replication of samples. In addition, with the greatly improved sensitivity, the present method can also significantly reduce the amount of total RNA required in a sample from micrograms to nanograms.

TABLE 1
Analysis of miRNAs in total RNA extracted from HeLa Cells

| | let-7b | mir-92 | mir-320 |
|---|---|---|---|
| | (copy/μg RNA) | (copy/μg RNA) | (copy/μg RNA) |
| This method | 5.7 ± 0.68 × 10⁷ | 3.6 ± 0.51 × 10⁷ | 0.83 ± 0.13 × 10⁷ |
| Northern blot | 5.5 ± 0.60 × 10⁷ | 3.8 ± 0.62 × 10⁷ | 0.75 ± 0.15 × 10⁷ |

As can be understood by one skilled in the art, many modifications to the exemplary embodiments described herein are possible. The invention, rather, is intended to encompass all such modification within its scope, as defined by the claims.

All documents referred to herein are fully incorporated by reference.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. All technical and scientific terms used herein have the same meaning as commonly understood by one of ordinary skill in the art of this invention, unless defined otherwise.

### REFERENCES

1. Lagos-Quintana, M., Rauhut, R., Lendeckel, W. and Tuschl, T. (2001) Identification of novel genes coding for small expressed RNAs. Science, 294, 853-858.
2. Lee, R. C. and Ambros, V. (2001) An extensive class of small RNAs in Caenorhabditis elegans. Science, 294, 862-864.
3. Reinhart, B. J., Slack, F. J., Basson, M., Bettinger, J. C., Pasquinelli, T., Rougvie, A. E., Horvitz, H. R. and Ruvkun, G. (2000) The 21 nucleotide let-7 RNA regulates developmental timing in Caenorhabditis elegans. Nature, 403, 901-906.
4. Calin, G. A., Dumitru, C. D., Shimizu, M., Bichi, R., Zupo, S., Noch, E., Aldler, H., Rattan, S., Keating, M., Rai, K. (2002) Frequent deletions and down-regulation of micro-RNA genes miR15 and miR16 at 13q14 in chronic lymphocytic leukemia. Proc. Natl Acad. Sci. USA, 99, 15524-15529.
5. Liu, C. G., Calin, G. A., Meloon, B., Gamliel, N., Sevignani, C., Ferracin, M., Dumitru, C. D., Shimizu, M., Zupo, S., Dono, M. (2004) An oligonucleotide microchip for genome-wide microRNA profiling in human and mouse tissues. Proc. Natl Acad. Sci. USA, 101, 9740-9744.
6. Calin, G. A., Liu, C. G., Sevignani, C., Ferracin, M., Felli, N., Dumitru, C. D., Shimizu, M., Cimmino, A., Zupo, S., Dono, M. (2004) MicroRNA profiling reveals distinct signatures in B cell chronic lymphocytic leukemias. Proc. Natl Acad. Sci. USA, 101, 11755-11760.
7. Schmittgen, T. D., Jiang, J., Liu, Q., and Yang, L. (2004) A highthroughput method to monitor the expression of microRNA precursors. Nucleic Acids Res., 32, e43.
8. Bartel, D. P. (2004) MicroRNAs: genomics, biogenesis, mechanism, and function. Cell, 116, 281-297.
9. Lu, J., Getz, G., Miska, E. A., Alvarez-Saavedra, E., Lamb, J., Peck, D., Sweet-Cordero, A., Ebert, B. L., Mak, R. H., Ferrando, A. A., Downing, J. R., Jacks, T., Horvitz, H. R. and Golub, T. R. (2005) MicroRNA expression profiles classify human cancers. Nature, 435, 834-838.
10. Lagos-Quintana, M., Rauhut, R., Lendeckel, W. and Tuschl, T. (2001) Identification of novel genes coding for small expressed RNAs. Science, 294, 853-858.
11. Lee, R. C. and Ambros, V. (2001) An extensive class of small RNAs in Caenorhabditis elegans. Science, 294, 862-864.
12. Reinhart, B. J., Slack, F. J., Basson, M., Bettinger, J. C., Pasquinelli, T., Rougvie, A. E., Horvitz, H. R. and Ruvkun, G. (2000) The 21 nucleotide let-7 RNA regulates developmental timing in Caenorhabditis elegans. Nature, 403, 901-906.
13. Calin, G. A., Dumitru, C. D., Shimizu, M., Bichi, R., Zupo, S., Noch, E., Aldler, H., Rattan, S., Keating, M., Rai, K. (2002) Frequent deletions and down-regulation of micro-RNA genes miR15 and miR16 at 13q14 in chronic lymphocytic leukemia. Proc. Natl Acad. Sci. USA, 99, 15524-15529.
14. Liu, C. G., Calin, G. A., Meloon, B., Gamliel, N., Sevignani, C., Ferracin, M., Dumitru, C. D., Shimizu, M., Zupo, S., Dono, M. (2004) An oligonucleotide microchip for genome-wide microRNA profiling in human and mouse tissues. Proc. Natl Acad. Sci. USA, 101, 9740-9744.
15. Calin, G. A., Liu, C. G., Sevignani, C., Ferracin, M., Felli, N., Dumitru, C. D., Shimizu, M., Cimmino, A., Zupo, S., Dono, M. (2004) MicroRNA profiling reveals distinct signatures in B cell chronic lymphocytic leukemias. Proc. Natl Acad. Sci. USA, 101, 11755-11760.
16. Schmittgen, T. D., Jiang, J., Liu, Q., and Yang, L. (2004) A highthroughput method to monitor the expression of microRNA precursors. Nucleic Acids Res., 32, e43.
17. Babak, T., Zhang, W., Morris, Q., Blencowe, B. J. and Hughes, T. R. (2004) Probing microRNAs with microarrays: tissue specificity and functional inference. RNA, 10, 1813-1819.
18. Liang, R. Q., Li, W., Li, Y., Tan, C. Y., Li, J. X., You-Xin Jin, Y. X. and Ruan, K. C. (2005) An oligonucleotide microarray for microRNA expression analysis based on labeling RNA with quantum dot and nanogold probe. Nucleic Acids Res., 33, e17.
19. Thomson, J. M., Parker, J., Perou, C. M. and Hammond, S. M. (2004) A custom microarray platform for analysis of microRNA gene expression. Nature Methods, 1, 47-53.
20. Zhang, Y., Kim, H. H. and Heller, A. (2003) Enzyme-amplified amperometric detection of 3000 copies of DNA in a 10-μL droplet at 0.5 fM concentration. Anal. Chem., 75, 3267-3269.
21. Xie, H., Zhang, C. and Gao, Z. (2004) Amperometric detection of nucleic acid at femtomolar levels with a nucleic acid/electrochemical activator bilayer on gold Electrode. Anal. Chem., 76, 1611-1617.
22. Xie, H., Yu, Y. H., Xie, F., Lao, Y. Z. and Gao, Z. (2004) A nucleic acid biosensor for gene expression analysis in nanograms of mRNA. Anal. Chem., 76, 4023-4029.
23. Piunno, P. A. E. and Krull, U. J. (2005) Trends in the development of nucleic acid biosensors for medical diagnostics. Anal. Bioanal. Chem., 381, 1004-1011.
24. Goss, C. A. and Abruna, H. D. (1985) Spectral, electrochemical and electrocatalytic properties of 1,10-phenanthroline-5,6-dione complex of transition metals. Inorg. Chem., 24, 4263-4267.
25. Griffiths-Jones, S. (2004) The microRNA registry, Nucleic Acids Res., 32, D109-D111.
26. Gao, Z. and Tansil, N. C. (2005) A photochemical nucleic acid biosensor, Nucleic Acids Res., 33, e123.
27. Clarke, M. J. (2002) Ruthenium metallopharmaceuticals, Coor. Chem. Rev., 232, 69-93.
28. Gray, H. B. and Winkler, J. R. (1996) Electron transfer in proteins. Ann. Rev. Biochem., 65, 537-561.
29. Hotze, A. C. G., Velders, A. H., Ugozzoli, F., Biagini-Cingi, M., Manotti-Lanfredi, A. M., Haasnoot, J. G. and Reedijk, J. (2000) Synthesis, characterization, and crystal structure of alpha-[Ru(azpy)₂(NO3)₂] (azpy=2-(Phenylazo)pyridine) and the products of its reactions with guanine derivatives. Inorg. Chem., 39, 3838-3844.
30. Tansil, N. C., Xie, H., Xie, F. and Gao, Z. (2005) Direct detection of DNA with an electrocatalytic threading intercalator. Anal Chem., 77, 126-134.
31. Tansil, N. C., Xie, H. and Gao, Z. (2005) An ultrasensitive nucleic acid biosensor based on the catalytic oxidation of guanine by a novel redox threading intercalator. Chem. Commun., 1064-1066.
32. Caruso, F., Rodda, E., Furlong, D. N., Niikura, K. and Okahata, Y. (1997) Quartz crystal microbalance study of DNA immobilization and hybridization for nucleic acid sensor development. Anal. Chem., 69, 2043-2049.
33. Shi, M. and Anson, F. C. (1998) Adsorption/desorption of the ligands 1,10-phenanthroline-5,6-dione and 1,10-phenanthroline-5,6-diol and their metal complexes on pyrolytic graphite electrodes. Anal. Chem., 70, 1489-1495.
34. Bard, A. J. and Faulkner, L. R. (2001) Electochemical Methods, John Willey & Sons, New York.
35. Barad, O., Meiri, E., Avniel, A., Aharonov, R., Barsilai, A., Bentwich, I., Einav, U., Gilad, S., Hurhan, P., IKarov, Y., Lobenhofer, E. K., Sharon, E., Shiboleth. Y. M., Shtutman, M., Bentwich, Z. and Einay, P. (2004) MicroRNA expression detected by oligonucleotide microarrays: system establishment and expression profiling in human tissues. Genome Res., 14, 2486-2494.
36. Allawi, H. T., Dahlberg, J. E., Olson, S., Lund, E., Olson, M., Ma, W. P., Takova, T., Neri, B. P. and Lyamichev, V. I. (2004) Quantification of microRNAs using a modified invader assay. RNA, 10, 1153-1161.
37. Nelson, P. T., Baldwin, D. A., Scearce, L. M., Oberholtzer, J. C., Tobias, J. W. and Mourelatos. Z. (2004) Microarray-based, high-throughput gene expression profiling of microRNAs. Nature Methods, 1, 155-161.

1. A method of detecting an analyte molecule in a sample, the method comprising:
labelling the analyte molecule in the sample with Ru(PD)₂Cl₂ so that the Ru(PD)₂Cl₂ undergoes ligand exchange to form an Ru(PD)₂Cl-analyte molecule complex;
contacting the sample with a working electrode, the working electrode having a surface with a capture molecule disposed thereon, to capture the Ru(PD)₂Cl-analyte molecule complex from the sample;
contacting a redox substrate with the captured Ru(PD)₂Cl-analyte molecule complex under conditions that allow for oxidation or reduction of the redox substrate; and
detecting current flow at the working electrode.

2. The method of claim 1 further comprising rinsing the electrode prior to contacting the redox substrate with the captured Ru(PD)₂Cl analyte molecule complex.

3. The method of claim 1 wherein the sample comprises a biological sample, a tissue culture, a tissue culture supernatant, a prepared biochemical sample, a field sample, a cell lysate or a fraction of a cell lysate.

4. The method of claim 3 wherein the biological sample comprises a biological fluid and the prepared biochemical sample comprises a prepped nucleic acid sample or a prepped protein sample.

5. The method of claim 4 wherein the sample comprises a prepped RNA sample.

6. The method of claim 1 wherein the analyte molecule comprises a protein, a peptide, DNA, mRNA, microRNA or a small molecule.

7. The method of claim 6 wherein the analyte molecule is a microRNA.

8. The method of claim 1 wherein the capture molecule comprises a protein, a peptide, DNA, RNA, an oligonucleotide, a ligand, a receptor, an antibody or a small molecule.

9. The method of claim 8 wherein the capture molecule comprises an oligonucleotide having a sequence complementary to the sequence of a microRNA.

10. The method of claim 1 wherein the redox substrate is hydrazine or ascorbic acid.

11. The method of claim 1 wherein the working electrode comprises carbon paste, carbon fiber, graphite, glassy carbon, gold, silver, copper, platinum, palladium, a metal oxide or a conductive polymer.

12. The method of claim 11 wherein the metal oxide is indium tin oxide and the conductive polymer is poly(3,4-ethylenedioxythiophene) (PEDOT) or polyaniline.

13. The method of claim 1 wherein the analyte molecule is labelled directly with the Ru(PD)₂Cl₂ complex.

14. The method of claim 1 wherein a labelling molecule is used to label the analyte molecule indirectly with the Ru(PD)₂Cl₂ complex.

15. The method of claim 14 wherein the labelling molecule comprises a protein, a peptide, a ligand, an antibody, a nucleic acid binding protein or protein domain or an oligonucleotide.
